(19) United States
(12) Patent Application Publication
(10) Pub. No.: US 2026/0288501 A1
(43) Pub. Date: Sep. 24, 2026

(54) PAGE-REGISTERED CONTEXTUAL READING ASSISTANCE FOR PHYSICAL PRINTED TEXT

(71) Applicant: Prithvi Karthikeyan Mittal, New York, NY (US)

(72) Inventor: Prithvi Karthikeyan Mittal, New York, NY (US)

(21) Appl. No.: 19/575,136

(22) Filed: Mar. 23, 2026

Related U.S. Application Data
(60) Provisional application No. 63/776,560, filed on Mar. 24, 2025.

(51) Int. Cl. G06F 9/451; G06F 40/279; G06V 30/32

(52) U.S. Cl. CPC G06F 9/453; G06F 40/279; G06V 30/32

(57) ABSTRACT

A reading assistance device, system, and method operate on live imagery of a physical printed page to identify selected text and provide contextual explanations. Optical character recognition performed on the live imagery generates recognized text tokens with positional metadata within a page coordinate system. A reader interaction signal associated with a selected region of the physical printed page is mapped into the page coordinate system to resolve a target token or phrase. Surrounding recognized text is processed to determine meaning within the printed material. Contextual output is generated based on the determined meaning and, in certain embodiments, reader context corresponding to age level, reading stage, or proficiency. The contextual output is rendered in spatial association with the selected text while the underlying printed text remains visible. The system operates without requiring retrieval of a pre-existing electronic copy.

### CROSS-REFERENCE TO RELATED APPLICATIONS

This application claims the benefit of U.S. Provisional Patent Application No. 63/776,560, filed Mar. 24, 2025, the disclosure of which is incorporated herein by reference in its entirety.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention

The present invention relates to computer vision-based reading assistance technologies and, more particularly, to systems, devices, and methods for processing live imagery of a physical printed page to generate spatially indexed text tokens, map reader interaction into a page coordinate system, and render contextual output anchored relative to the printed material.

More particularly, the disclosure concerns contextual reading assistance architectures that perform spatial mapping of recognized text tokens, coordinate transformation between image and page domains, interaction-based token resolution, meaning determination from surrounding printed text, and generation of explanatory output that, in certain embodiments, is calibrated according to reader context, thereby enabling contextual output in page-registered relation to the physical printed page.

### Description of Related Art

Readers of physical books, printed educational materials, manuals, worksheets, newspapers, and other paper-based media frequently encounter words, phrases, idioms, and grammatical constructions that are unfamiliar or difficult to understand. Conventional approaches for obtaining assistance often require the reader to interrupt reading, consult a separate dictionary, use a mobile device, or access an electronic version of the material.

Existing reading-assistance systems typically replace the reader's interaction with a physical page with interaction through a separate digital interface. Many such systems rely on retrieving an electronic copy of a document from a database or server and then performing operations on that digital representation. Other systems display explanations, translations, or annotations on an external device screen, thereby requiring the reader to shift attention away from the physical printed page. These approaches interrupt reading flow and reduce engagement with the printed page.

Existing systems that attempt to interact with printed material commonly operate at a page level or document level, rather than at the level of individual tokens or phrases positioned on the page. As a result, such systems frequently translate, substitute, or replace entire sections of text rather than providing localized contextual output associated with a selected word or phrase within the printed material itself.

Systems that depend on a previously stored electronic copy of the document are also limited in situations in which no corresponding digital edition is available, in which network connectivity is unavailable or undesirable, or in which privacy considerations favor local processing. Such systems may further fail to preserve spatial correspondence between a specific printed token and the output presented to the reader.

Certain optical translation and overlay systems may acquire an image of printed text and then substitute translated content for a broader text region, a line, or an entire page. Such approaches may obscure the original text, alter the visible page content, or otherwise direct the reader away from the underlying printed material rather than maintaining token-level interaction with the physical page itself.

Certain augmented-reality annotation systems may position information relative to a document only after recognizing a pre-existing digital document copy, page identifier, or marker set. Such approaches may not derive token positions directly from live OCR of the physical page and therefore may not provide token-level resolution based on recognized text coordinates generated from the live page image itself.

Certain scanning-pen and line-scanning devices capture a narrow strip or line of text and may require guided scanning movement across the page. Such devices may not establish a page coordinate system for a page region, may not map an independently detected interaction region to OCR token positions on the page, and may not provide page-registered contextual output anchored to a selected token or phrase within a broader physical page environment.

Accordingly, there remains a need for a system capable of capturing live imagery of a physical printed page, generating token-level positional data for recognized text, mapping a reader interaction region into a page coordinate system representing spatial positions on the physical printed page, resolving reader intent with respect to specific printed text on that page, and delivering localized contextual output while maintaining the reader's engagement with the printed material itself.

### BRIEF SUMMARY OF THE INVENTION

The present invention relates to a contextual reading assistance architecture for physical printed text. The architecture captures live imagery of a physical printed page, performs optical character recognition on the live imagery to generate recognized text tokens with positional metadata within a page coordinate system corresponding to the physical printed page, receives a reader interaction signal corresponding to a selected region of the physical printed page, maps the selected region into the page coordinate system using a coordinate transformation, resolves a target token or phrase based on positional relationships between the selected region and the positional metadata of the recognized tokens, extracts contextual text from surrounding recognized text to determine a meaning of the target token or phrase within the printed material, generates contextual output that is semantically appropriate to the determined meaning and, in certain embodiments, explanatorily calibrated according to reader context corresponding to a reader cohort or category, and renders the contextual output in page-registered relation to the physical printed page while the underlying printed text remains visible.

In certain embodiments, the system operates on live imagery of the physical printed page and does not require retrieval of an electronic copy of the page from a remote database, server, or document repository. Instead, the system generates recognized text tokens and corresponding positional metadata within the page coordinate system directly from imagery of the physical printed material presented to the reader.

In certain embodiments, the OCR processing module segments OCR output into independently addressable tokens. The tokens may include words, subwords, punctuation-associated units, phrase components, or combinations thereof. Each token may be stored with independent positional metadata so that the token can be individually referenced, mapped relative to a selection region, grouped with adjacent tokens, and used as an anchor for contextual output.

In certain embodiments, the positional metadata for each token may include one or more of a bounding box, centroid, polygon, baseline coordinate, token index, reading-order position, line association, paragraph association, confidence value, or other spatial or structural metadata within a page coordinate system.

In certain embodiments, the page coordinate system may be derived from page edges, page corners, page geometry, image-derived page boundaries, fiducial features, or combinations thereof. Coordinate transforms may be generated between image coordinates, page coordinates, and display coordinates to map token locations to the physical printed page and to a display configured to present contextual output.

In certain embodiments, the selection signal may be derived from finger pointing, stylus interaction, touch input, gesture recognition, gaze detection, proximity sensing, motion sensing, highlight detection, or another reader interaction mechanism. The system maps a detected interaction region into the page coordinate system and compares the mapped interaction region to the OCR-generated token coordinates to resolve the target token or phrase intended by the reader.

In certain embodiments, the system identifies a candidate token set from recognized text tokens whose spatial coordinates intersect, overlap, or lie within a threshold distance of the mapped interaction region. The system may resolve a target token using overlap analysis, centroid proximity, hit-testing, token confidence scoring, line continuity, phrase grouping heuristics, or combinations thereof. The system may resolve a single token, a multi-token phrase, or a multi-line phrase according to the positional relationship between the interaction region and the OCR token positions.

In certain embodiments, after a target token or phrase has been resolved, the system extracts surrounding recognized text from nearby recognized tokens, identifies sentence or clause boundaries, determines punctuation patterns and grammatical relationships, and provides the resulting context to a contextual processing module. Such contextual extraction may support homograph disambiguation, idiom recognition, phrase interpretation, and selection of an explanation appropriate to the detected usage of the selected text.

In certain embodiments, the contextual processing module may retrieve, select, rank, or generate contextual output using one or more of a local lexical database, a contextual language model, rule-based disambiguation, or ranking of candidate meanings. The contextual output may include a definition, pronunciation guidance, simplified explanation, translation, grammatical clarification, part-of-speech information, morphological information, visual explanatory content, auditory explanatory content, or combinations thereof.

In certain embodiments, the display renders the contextual output adjacent to or otherwise spatially associated with the selected token or phrase on the same physical printed page from which the text was captured. The rendering may be page-registered such that the displayed output is anchored to the coordinate location of the selected token while leaving the underlying printed text visible and readable, including by offsetting the displayed output into adjacent whitespace, a margin, or another non-obscuring region.

In certain embodiments, the relevant sensing, OCR processing, intent resolution, contextual processing, and rendering components are integrated within a single reading assistance device. In other embodiments, one or more such components or functions may be locally distributed across multiple cooperating devices while still operating on live OCR of the physical printed page and without requiring retrieval of a pre-existing electronic copy of the physical printed page.

In certain embodiments, context associated with a selected token or phrase includes page context and, in certain embodiments, reader context. Page context may include surrounding recognized text, sentence boundaries, clause boundaries, punctuation patterns, grammatical relationships, or other context derived from the physical printed page, and may be used to determine a meaning of the selected token or phrase within the surrounding printed material. Reader context may correspond to a reader cohort or category indicative of age level, reading stage, reading proficiency, vocabulary level, language preference, or assistance preference, and may be used to determine a level, depth, phrasing, modality, or presentation of the explanation provided as contextual output. The contextual output may thereby be semantically appropriate to the page context and explanatorily appropriate to the reader cohort or category.

In certain embodiments, the system operates substantially offline using local memory, local lexical resources, and one or more on-device contextual language models. Such local operation may be preferred for privacy, output integrity, and child-appropriate control. In certain embodiments, remote or hybrid supplementation may be invoked as a fallback when greater contextual span or increased computational demand makes fully local generation less suitable. Such fallback does not alter the underlying architecture. The system continues to operate on live imagery of the physical printed page, maps reader interaction into the page coordinate system, resolves the target token or phrase from OCR-generated token coordinates, and does not require retrieval of a pre-existing electronic copy of the physical printed page.

The systems and methods described herein provide several technical advantages relative to conventional reading-assistance technologies. First, the invention operates directly on live imagery of a physical printed page rather than relying on retrieval of a pre-existing electronic copy of the physical printed page. By performing OCR on the captured page image and generating spatial coordinates for recognized tokens, the system can identify specific words or phrases directly within the physical page environment.

Second, the invention enables token-level interaction with printed material by mapping a reader selection signal to OCR-generated token positions within a page coordinate system. This allows contextual output to be directed to individual tokens or phrases rather than requiring page-level translation or substitution.

Third, the invention provides page-registered augmentation of printed text. Contextual output is rendered adjacent to, and anchored to, the corresponding token location while the underlying printed text remains visible, enabling continuous reading.

Fourth, the architecture enables continuous reading flow by performing OCR, token resolution, contextual analysis, contextual output generation, and rendering within a reading assistance device or local cooperating architecture without requiring switching to a separate interface, while delivering contextual output that is semantically appropriate to the printed context and, in certain embodiments, calibrated to reader context.

Fifth, the architecture supports substantially offline local processing as a preferred operating mode, thereby reducing latency and dependence on network connectivity during reading assistance.

### BRIEF DESCRIPTION OF THE SEVERAL VIEWS OF THE DRAWING(S)

The accompanying drawings illustrate example embodiments of the present disclosure and are provided for purposes of illustration. The drawings are schematic in nature and are not necessarily to scale.

FIG. 1 is a schematic view of a reading assistance device positioned relative to a physical printed page.

FIG. 2 is a schematic block diagram of the reading assistance device including imaging sensor 104, processor 108, memory 110, and display 106.

FIG. 3 is a schematic view illustrating page-registered rendering of contextual output relative to selected printed text on a physical printed page, with underlying printed text remaining visible.

FIG. 4 is a flow diagram illustrating a method for providing contextual reading assistance for physical printed text, including capture of live imagery, OCR, reader interaction detection, target token or phrase resolution, contextual output generation, and page-registered rendering.

### DETAILED DESCRIPTION OF THE INVENTION

Reference will now be made in detail to various illustrative embodiments of the invention. The embodiments described herein are schematic and exemplary and are not intended to limit the scope of the claimed invention. Like reference numerals designate like or corresponding features throughout the figures and description.

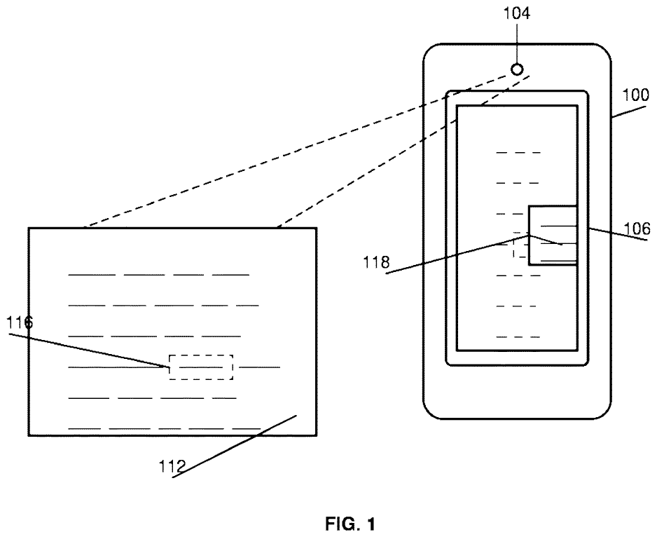

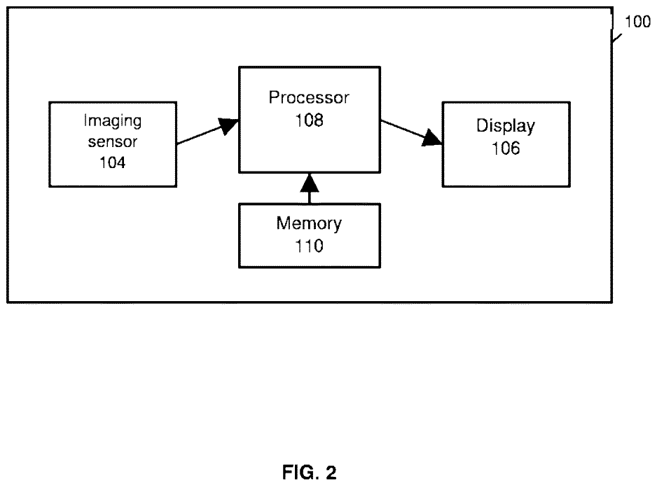

As shown schematically in FIG. 1, a reading assistance device 100 may be positioned on, over, or in proximity to a physical printed page 112 bearing printed text 114. The device 100 includes a body 102. As shown in FIG. 2, the device 100 further includes imaging sensor 104, display 106, processor 108, and memory 110. In certain embodiments, the device 100 further includes one or more optional sensors 142 including touch sensors, proximity sensors, motion sensors, inertial sensors, infrared sensors, gaze-detection sensors, or combinations thereof.

The body 102 may take various forms and is not limited to a bookmark. By way of example, the body 102 may be configured as a bookmark, a reading bar, a transparent overlay, a ruler-like device, or another page-positionable structure capable of maintaining a spatial relationship with the physical printed page 112. The body 102 may be positioned directly on the page, slightly above the page, or movable relative to the page such that captured imagery and rendered contextual output correspond to a local region of the physical printed page 112.

In operation, the imaging sensor 104 captures live imagery of the physical printed page 112. The processor 108 executes instructions stored in memory 110 to process the live imagery directly. The disclosed architecture operates on imagery of the physical printed page and does not require retrieval of an electronic copy of the page from a remote database, server, or document repository to identify text.

In certain embodiments, the device 100 establishes or accesses a page coordinate system 124 representing spatial positions on the physical printed page 112. The page coordinate system 124 may be derived from page edges, page corners, page geometry, image-derived page boundaries, fiducial features, or combinations thereof. The page coordinate system 124 may represent an entire page, a portion of a page, or a region within the field of view of the imaging sensor 104.

In certain embodiments, processor 108 executes a coordinate transform module 126 that generates a transformation between image coordinates of the live imagery and the page coordinate system 124. The coordinate transform module 126 may employ a homography, affine transformation, perspective transformation, calibration matrix, or another geometric mapping derived from observed page geometry. Live imagery may be represented in an image coordinate system 148, and page boundaries or page-corner features 156 may be used to derive the page coordinate system 124. The coordinate transform module 126 may further map the page coordinate system 124 to display coordinates associated with the display 106, including a display coordinate system 150, such that contextual output rendered by the display 106 is page-registered to the physical printed page 112. A selected region mapped into the page coordinate system 124 may be represented as a mapped selected region 152, and an anchor point 154 associated with a resolved target token or phrase 118 may be mapped into the display coordinate system 150 for page-registered rendering.

In certain embodiments, processor 108 executes an OCR module 128 to identify recognized text tokens from the printed text 114 and to generate token coordinates 122 corresponding to the recognized text tokens within the page coordinate system 124. In certain embodiments, the OCR module 128 segments OCR output into independently addressable tokens including words, subwords, punctuation-associated units, phrase components, or combinations thereof.

Each recognized token may be associated with positional metadata including a bounding box, centroid, polygon, baseline coordinate, token index, reading-order position, line identifier, paragraph identifier, confidence value, or another spatial or structural attribute. The positional metadata enables each token to be individually selected, grouped, ranked, or used as an anchor for contextual output.

In certain embodiments, the recognized tokens and associated positional metadata are stored in memory 110 as tokenized page data. The tokenized page data may include token indices, adjacency relationships, line groupings, sentence groupings, punctuation associations, and OCR confidence values. Because the tokens are independently addressable, the system can compare a selected region on the page to candidate tokens without requiring substitution or replacement of the full page text.

In certain embodiments, the device 100 or an associated system receives a selection signal represented as a reader interaction region 116 corresponding to a region of the physical printed page 112. The interaction region 116 may be represented as a point, area, dwell region, stroke path, highlight region, polygon, or proximity envelope within the page coordinate system 124.

The reader interaction region 116 may be derived from one or more modalities including finger pointing detected by the imaging sensor 104, highlight detection from captured imagery, gesture input, gaze-based interaction, touch input, or stylus input. In certain embodiments, multiple modalities may be combined to determine a higher-confidence interaction region.

In certain embodiments, processor 108 executes an intent resolution module 130 that maps an interaction region detected in image coordinates into the page coordinate system 124 and compares the mapped interaction region with token coordinates 122 to determine a target token or phrase 118. A candidate token set 144 may be generated from tokens whose positional metadata intersects, overlaps, or lies within a threshold distance of the interaction region.

The intent resolution module 130 may perform overlap analysis, centroid proximity analysis, hit-testing, token confidence scoring, line continuity analysis, or phrase grouping heuristics. Candidate tokens may be ranked based on intersection extent, centroid distance, reading-order continuity, OCR confidence, or punctuation boundaries. A highest-ranking token or token group is selected as the target token or phrase 118.

The target token or phrase 118 may correspond to a single token or multiple adjacent tokens based on the extent of the interaction region or grouping heuristics.

In certain embodiments, the target token or phrase 118 may extend across multiple lines. Tokens may be grouped across line breaks based on positional continuity, reading-order relationships, and punctuation boundaries.

In a highlight-based embodiment, the imaging sensor 104 captures a highlighted region, which is detected using region-detection techniques such as segmentation or contour analysis and compared with token coordinates 122 to identify intersecting tokens.

In a finger-pointing embodiment, the imaging sensor 104 detects a fingertip location and maps it into the page coordinate system 124. In a gaze-based embodiment, gaze location is estimated relative to the page coordinate system. In a gesture-based embodiment, motion trajectories are interpreted as region selections.

Once the target token or phrase 118 is resolved, processor 108 may execute a contextual processing module 132 to extract a context window 146 from surrounding recognized tokens. The context window may include preceding and following tokens, sentence boundaries, clause boundaries, punctuation patterns, and grammatical relationships.

The extracted context enables disambiguation of multiple meanings of the target token or phrase 118, including homograph disambiguation, idiom recognition, and grammatical interpretation.

In certain embodiments, the contextual processing module 132 accesses a local lexical database 136 containing lexical information such as definitions, pronunciations, translations, grammatical labels, or example usages.

In certain embodiments, the contextual processing module 132 employs a contextual language model 138 configured to generate or refine contextual output based on the extracted context. Rule-based disambiguation may be used independently or in combination with the language model.

In certain embodiments, assistance generator 134 generates contextual output responsive to the resolved target token or phrase 118. The contextual output may include a definition, pronunciation guidance, translation, simplified explanation, grammatical information, visual explanatory content such as an image, illustration, diagram, map, symbol, or other graphical content corresponding to meaning, usage, category, or concept, and/or auditory explanatory content such as spoken pronunciation, spoken explanation, or other audio corresponding to meaning, usage, category, or concept. Such visual explanatory content may be particularly helpful for a child reader or developing reader.

In certain embodiments, reader context used to adapt the contextual output corresponds to a reader cohort or category indicative of age level, reading stage, reading proficiency, vocabulary level, language preference, or assistance preference. The contextual output may be adapted according to such reader context to vary level, depth, phrasing, modality, or presentation while remaining responsive to the meaning determined from the surrounding context. In certain embodiments, the reader context may be stored in a reader profile store 140. Individualized reader profiling is not required.

In certain embodiments, the system operates substantially offline as a preferred mode. OCR processing, token mapping, intent resolution, contextual extraction, contextual output generation, and rendering may be performed locally without reliance on network connectivity. In certain embodiments, remote or hybrid processing may supplement contextual output generation as a fallback when greater contextual span or increased computational demand makes fully local generation less suitable. Such fallback does not alter the underlying architecture and does not require retrieval of a pre-existing electronic copy of the physical printed page.

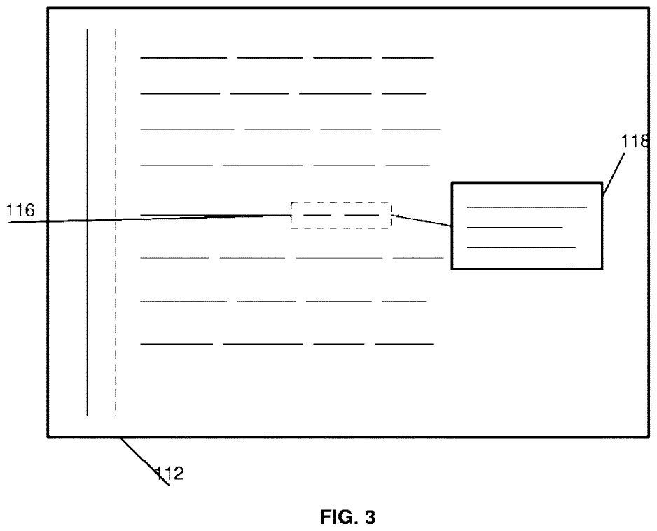

As shown in FIG. 3, the display 106 renders contextual output in page-registered relation to the target token or phrase 118. The rendered output is positioned by mapping an anchor point 154 into display coordinates such that the output remains aligned with the physical printed page.

The contextual output may be positioned adjacent to the selected text, including in whitespace or margins, to preserve visibility of the underlying printed text 114 while maintaining visual association with the selected token or phrase. The imaging sensor 104 may capture successive live images while maintaining or updating the page coordinate system 124 based on detected page features, and the OCR module 128 may generate tokenized page data including positional metadata for each recognized token. A reader interaction region 116 may be mapped into the page coordinate system 124 and compared to token coordinates 122 to identify a candidate token set 144, the candidate tokens being ranked so that a highest-ranking token or token group is selected as the target token or phrase 118.

Contextual output is generated based on surrounding recognized tokens and rendered by mapping an anchor point 154 into display coordinates such that the output is positioned relative to the physical printed page without obscuring the underlying text. The disclosed system differs from systems that replace or translate entire pages, as it provides localized contextual output at the token or phrase level.

The disclosed system differs from augmented-reality systems that rely on pre-existing digital document copies, as token positions are derived directly from live imagery of the physical printed page.

The disclosed system differs from scanning devices that capture only a narrow line of text, as it operates within a page coordinate system representing a page region and resolves reader interaction relative to token coordinates derived from live imagery of the physical printed page, thereby enabling page-registered rendering without replacing the printed content.

The display 106 may comprise a transparent display, OLED, microLED, electrophoretic display, or projection-based display.

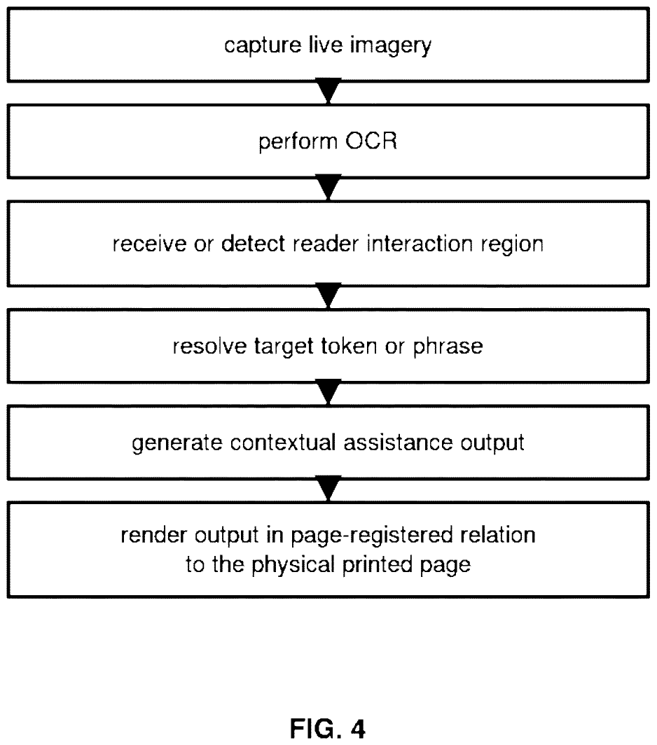

FIG. 4 illustrates a method including capturing live imagery, performing OCR, detecting reader interaction, resolving a target token or phrase, generating contextual output, and rendering the contextual output in page-registered relation to the physical printed page.

The disclosed embodiments are illustrative and not limiting. Modifications may be made without departing from the scope of the invention.

“Page-registered” refers to rendering aligned to positions on the physical printed page. “Reader interaction region” refers to a region representing user input relative to the page. “Contextual output” refers to output generated based on surrounding text associated with a selected token or phrase and, in certain embodiments, reader context associated with a reader cohort or category, and may include textual explanatory content, visual explanatory content, and/or auditory explanatory content. “Underlying printed text remains visible” means the printed text is not replaced and remains readable. “Token” includes words, subwords, or other OCR-recognized units.

In one illustrative implementation, a reader in a reader cohort or category is reading a physical printed page 112 containing a selected word or phrase requiring clarification. The reading assistance device 100 captures live imagery of the physical printed page 112 using the imaging sensor 104. The OCR module 128 generates recognized text tokens and corresponding token coordinates 122 within the page coordinate system 124. A reader interaction region 116 corresponding to finger pointing, gesture input, gaze, or another selection input is mapped into the page coordinate system 124, and the intent resolution module 130 identifies a target token or phrase 118 based on positional relationships to the token coordinates 122. The contextual processing module 132 extracts surrounding text to determine a meaning of the selected token or phrase within the printed material. After the meaning is determined from the page context, the assistance generator 134 retrieves, selects, or generates an explanation calibrated for the relevant reader cohort or category using one or more of the local lexical database 136 and the contextual language model 138. The explanation may be calibrated according to age level, reading stage, reading proficiency, vocabulary level, language preference, or assistance preference associated with the reader cohort or category. The display 106 renders contextual output adjacent to the selected token or phrase on the physical printed page 112, including in nearby whitespace, such that the underlying printed text remains visible. The reader thereby receives contextual output that is semantically appropriate to the page context and explanatorily appropriate to the reader cohort or category without shifting attention away from the physical printed page.

In various embodiments, the contextual output may comprise a definition, simplified explanation, translation, pronunciation guidance, grammatical clarification, visual explanatory content, auditory explanatory content, or combinations thereof.

I claim:

1. A reading assistance device for interacting with physical printed text, the device comprising:
an imaging sensor configured to capture live imagery of a physical printed page containing printed text;
a processor;
memory operatively coupled to the processor; and
a display positioned relative to the physical printed page and configured to present visual output in page-registered relation to the physical printed page,
wherein the memory stores instructions that, when executed by the processor, cause the device to:
capture live imagery of the physical printed page using the imaging sensor;
establish or access a page coordinate system corresponding to the physical printed page;
perform optical character recognition on the live imagery to generate a plurality of recognized text tokens, each recognized text token being associated with positional metadata within the page coordinate system;
receive a selection signal associated with a selected region of the physical printed page;
map the selected region into the page coordinate system;
determine, based on a positional relationship between the selected region and the positional metadata of the recognized text tokens, a target token or phrase on the physical printed page from the recognized text tokens generated from the live imagery, without requiring retrieval of a pre-existing electronic copy of the physical printed page;
extract contextual text associated with the target token or phrase from the recognized text tokens;
generate contextual output comprising textual explanatory content and optionally visual explanatory content and/or auditory explanatory content; and
render, by the display, the contextual output at a display position determined from the positional metadata of the target token or phrase such that the contextual output is page-registered relative to the physical printed page while the underlying printed text remains visible.

2. The device of claim 1, wherein the positional metadata comprises a bounding box and a token index within the page coordinate system.

3. The device of claim 1, wherein the device is configured to determine a coordinate transformation between image coordinates of the live imagery and the page coordinate system and further between the page coordinate system and display coordinates for mapping the selected region and the contextual output relative to the physical printed page.

4. The device of claim 1, wherein the selection signal comprises a highlighted region automatically detected from the live imagery of the physical printed page.

5. The device of claim 1, wherein the selection signal comprises a finger-pointing location detected within the live imagery relative to the physical printed page.

6. The device of claim 1, wherein the selection signal comprises gesture interaction, gaze-based interaction, touch interaction, or combinations thereof.

7. The device of claim 1, further comprising a body having a form factor selected from the group consisting of a bookmark, a reading bar, a transparent overlay, a ruler-like device, and an elongated reading guide.

8. The device of claim 1, wherein the display comprises an electrophoretic e-ink display, an OLED display, a microLED display, a transparent display, or a projection display configured to present the contextual output adjacent to the target token or phrase.

9. A contextual reading assistance system for physical printed text, comprising:
an imaging subsystem configured to capture live imagery of a physical printed page; an optical character recognition subsystem configured to perform optical character recognition directly on the live imagery and generate recognized text tokens each associated with positional metadata including spatial coordinates relative to the physical printed page; an intent resolution subsystem configured to receive a reader interaction signal associated with a selected region of the physical printed page and determine, based on a positional relationship between the selected region and the spatial coordinates, a target token or phrase; a contextual processing subsystem configured to extract surrounding context from the recognized text tokens and generate contextual output for the target token or phrase; and a display subsystem configured to render the contextual output in page-registered relation to the target token or phrase on the physical printed page while the underlying printed text remains visible.

10. The system of claim 9, wherein the contextual processing subsystem comprises a local lexical database storing lexical information including definitions, translations, pronunciations, or explanatory content.

11. The system of claim 9, wherein the contextual processing subsystem comprises a contextual language model configured to generate or refine the contextual output based on the surrounding context.

12. The system of claim 9, wherein the system is configured to generate the contextual output substantially offline using local resources and without requiring retrieval of a pre-existing electronic copy of the physical printed page.

13. The system of claim 9, further comprising a reader profile store configured to store reader context corresponding to a reader cohort or category including one or more of age level, reading stage, reading proficiency, vocabulary level, language preference, or assistance preference, wherein the contextual processing subsystem is configured to adapt the contextual output according to the reader context.

14. The system of claim 9, wherein the intent resolution subsystem is configured to resolve the target token or phrase as a plurality of adjacent recognized text tokens, including recognized text tokens spanning multiple lines.

15. A method of providing contextual reading assistance for physical printed text, the method comprising:
capturing live imagery of a physical printed page containing printed text;
performing optical character recognition directly on the live imagery to generate recognized text tokens each associated with positional metadata including spatial coordinates, without requiring retrieval of a pre-existing electronic copy of the physical printed page;
generating a page coordinate system corresponding to the physical printed page;
determining a coordinate transformation between image coordinates and the page coordinate system;
receiving a reader interaction signal associated with a selected region of the physical printed page;
mapping the selected region into the page coordinate system;
resolving, based on a positional relationship between the selected region and the spatial coordinates of the recognized text tokens, a target token or phrase;
extracting contextual text associated with the target token or phrase;
generating contextual output; and
rendering the contextual output in page-registered relation to the target token or phrase on the physical printed page while the underlying printed text remains visible.

16. The method of claim 15, further comprising generating the page coordinate system by detecting page geometry within the live imagery including page edges, page corners, page boundaries, fiducial features, or combinations thereof.

17. The method of claim 15, wherein resolving the target token or phrase comprises performing overlap analysis between the mapped region and token bounding boxes, centroid proximity analysis, hit-testing, token confidence scoring, line continuity analysis, or phrase grouping heuristics.

18. The method of claim 15, wherein extracting contextual text comprises identifying preceding tokens, following tokens, sentence boundaries, clause boundaries, punctuation patterns, or grammatical relationships associated with the target token or phrase.

19. The method of claim 15, wherein generating the contextual output comprises using local resources as a preferred operating mode and supplementing generation of the contextual output with remote or hybrid processing only as a fallback when greater contextual span or increased computational demand makes fully local generation less suitable, wherein such fallback does not alter the underlying architecture, and wherein capturing the live imagery, performing optical character recognition on the live imagery, mapping the selected region into the page coordinate system, and resolving the target token or phrase from OCR-generated token coordinates are performed without requiring retrieval of a pre-existing electronic copy of the physical printed page.

20. The method of claim 15, wherein generating the contextual output comprises determining a meaning of the target token or phrase from the surrounding context and, after determining the meaning, selecting or generating an explanation, including a simplified explanation, calibrated to reader context corresponding to a reader cohort or category including one or more of age level, reading stage, reading proficiency, vocabulary level, language preference, or assistance preference.
